(19) United States
(12) Patent Application Publication
(10) Pub. No.: US 2017/0084107 A1
(43) Pub. Date: Mar. 23, 2017

(54) DEVICE WITH AN OPERATOR CONTROL ELEMENT WHICH IS ASSOCIATED WITH A HANDLE

(71) Applicant: NOVOMATIC AG, Gumpoldskirchen (AT)

(72) Inventor: Alois HOMER, Gumpoldskirchen (AT)

(21) Appl. No.: 15/363,155

(22) Filed: Nov. 29, 2016

Related U.S. Application Data
(63) Continuation of application No. PCT/EP2015/060948, filed on May 19, 2015.

(30) Foreign Application Priority Data
May 30, 2014 (DE) 10 2014 008 159.1

(51) Int. Cl. G07F 17/32

(52) U.S. Cl. CPC G07F 17/3209; G07F 17/3244; G07F 17/3213; G07F 17/3206

(57) ABSTRACT

A device in which an operator control element is associated with a handle, wherein the operator control element is arranged in such a way that when one or more fingers of a hand wraps around the handle, the thumb of the hand can be placed on the operator control element.

### CROSS-REFERENCE TO RELATED APPLICATIONS

This application is a continuation under 35 U.S.C. §120 of PCT Application No. PCT/EP2015/060948, filed May 19, 2015, which claims priority to DE Patent Application No. DE 102014008159.1, filed on May 30, 2014. The entire contents of each of the aforementioned applications are hereby incorporated by reference.

### BACKGROUND OF THE INVENTION

Field of the Invention

The present disclosure relates to devices in which an operator control element is associated with a handle, wherein the operator control element is arranged in such a way that when an index finger and/or middle finger and/or ring finger and/or little finger of a hand wrap/wraps around the handle, the thumb of said hand can be placed on the operator control element.

Description of the Related Technology

Devices of this kind comprising an operator control element can be, in particular, gaming and/or entertainment and/or betting machines, as are used in casinos or amusement arcades, or cash- or token-operated devices, such as vending machines, from which, for example, goods or playing chips can be purchased, or access control systems, such as turnstiles or entry barrier systems.

The operator control element serves to perform different functions depending on the type of device. By way of example, the operator control element can be a start button with which a game is started. However, the operator control element can also serve as a gamble button for other gaming functions, for example can function as a stop button for stopping the reels in a reel-based game or sending in the ball in a roulette game.

Here, the operator control element can be designed, in particular, in the form of a pushbutton which can be pushed down by the thumb or reacts to pressure of the applied thumb. In principle, the operator control element can also be designed as a touchscreen button which reacts as early as when contact is made. Other designs of the operator control element can be sliding switches, rocker buttons or the like.

In devices of this kind which have been known to date, handling and usability of the operator control element are, however, sometimes cumbersome for the user and rather obstructive for operation of other device elements since the finger or thumb which is to be positioned on the operator control element sets the other fingers of the hand in a specific position.

A device of the kind mentioned in the introductory part is known, for example, from DE 10 2007 042 632 A1, wherein, in this document, an operator control button panel, which is provided below the screens of the gaming machine, is provided with a handle on which the operator of the device can place his right hand. In this case, an operator control element in the form of a start button for starting a game, which start button can be operated by a thumb which is splayed from the handle, is provided obliquely beneath the handle. However, this operator control button, which is arranged on the front face of the device, is not arranged in a manner which is suitable for all operators of the device equally.

US 2009/0073121 A1 further discloses an operator control device in which the operator control element comprises an operating plate which is curved in the manner of a mushroom head and which is mounted such that it can be tilted on a central axial shaft. The fingers which can be placed on the operating plate can tilt the plate and therefore control a cursor on the screen. In addition, additional operator control buttons are provided on the tiltable operating plate, it being possible to trigger additional control functions in the manner of a mouse click by means of said additional operator control buttons.

DE 199 44 140 A1 discloses a cash-operated device in the form of a gaming machine, in which a start switch with which a game can be started on the entertainment device is provided as operator control element, wherein a fingerprint sensor is integrated into the start switch.

US 2014/0028439 A1 further discloses a door handle into which an operator control element is integrated in order to release an electronic door lock as a function of the detected fingerprint. In this case, the operator control element is provided on a front side of the handle, which front side faces the user, in the region of the rotation axis of the door handle. However, problems can occur here. When the door handle is turned, the thumb which is to be placed on the operator control element can slip, with the result that the biometric data cannot be cleanly detected.

Furthermore, WO 2011/041619 A1 discloses a gaming machine which comprises a separate operator control tablet which can be connected to a gaming computer system by cable.

### SUMMARY

The present disclosure is based on the object of providing an improved device of the kind mentioned in the introductory part, which device avoids the disadvantages of the prior art and develops said prior art in an advantageous manner. In particular, handling and usability of the operator control element on the device is intended to be simplified and improved in ergonomic terms.

Therefore, it is proposed to design the handle to be adjustable in respect of its position and/or orientation in order to be able to adapt the physical association between the handle and the operator control element to a respective user. In one embodiment, in order to be able to use the operator control element such that it is arranged in a manner which is suitable equally for the left hand and the right hand, the position of the handle can be varied in such a way that the handle can be moved to at least two operating positions relative to the operator control element, one operating position of said operating positions being situated with respect to the operator control element such that the handle can be grasped by the right hand and the right-hand thumb can be placed on the operator control element and the other operating position of said operating positions being situated such that the handle can be grasped by the left hand and the left-hand thumb can be placed on the operator control element. In another embodiment, the handle is ideally designed in the form of a rod for simple and easy handling.

In this case, the operating positions of the handle are advantageously positioned in such a way that the operator control element is arranged next to the handle in the respective operating position within reach of the thumb such that a thumb which is extending away from the handle comes to lie on the operator control element by way of the tip of the thumb. If the index finger, middle finger, ring finger and/or little finger of a hand of the user wrap/wraps around the handle, the thumb comes to lie on the operator control element in an ergonomically expedient manner when the thumb is in the natural position in which the thumb extends away from the handle around which the finger/fingers are wrapped.

In an advantageous development of one embodiment, the operator control element can in this case not be arranged or oriented rigidly in a fixed position relative to the handle or relative to the finger support surface, but rather can be arranged in a movable manner or mounted in a movable manner in order to be able to be moved individually, that is to say positions which are suitable for the respective user and the hand of said user.

In particular, the operator control element can be mounted such that it can be rotated or tilted about at least one rotation axis which can be oriented at least approximately parallel to a plane in which the bearing surface of the operator control element lies or which the bearing surface adjoins. By way of example, the operator control element, when it is arranged on an upright housing side, can be tilted about an upright tilting axis and/or can be tilted or rotated about a horizontal tilting axis, which extends parallel to the upright housing side on which the operator control element is arranged.

Here, the handle can be designed or mounted, for example, in a reconnectable manner such that it can be moved to two different positions by reconnection. As an alternative or in addition, the handle can also be mounted in a pivotable manner so that it can pivot back and forth between the two above-mentioned operating positions. As an alternative or in addition, the handle can also be mounted in a displaceable manner, for example along the longitudinal axis of said handle, so that sometimes it comes to lie predominantly to the left and, at other times, predominantly to the right of the operator control element and is accordingly selectively positioned in a manner suitable for the left hand or the right hand in relation to the operator control element.

The ability to vary the position of the handle relative to the operator control element can advantageously be formed in such a way that the operating positions which can be approached or can be set are symmetrical in relation to the operator control element. In particular, the operating positions which are intended for left-handed and right-handed operation can be arranged symmetrically with respect to a plane of symmetry or an axis of symmetry which is oriented centrally in relation to the operator control element. In particular, the two operating positions can be arranged symmetrically with respect to an upright plane of symmetry which passes centrally through the operator control element. If foldable or pivotable mounting of the handle is provided, a pivot axis can be arranged in said plane of symmetry or can be arranged centrally above or below the operator control element.

In a development of one embodiment, single-axis pivotability of the handle about a pivot axis which is arranged fixed to the housing can be provided in this case, wherein said pivot axis can extend, for example, perpendicular to the longitudinal direction of the handle in the region of a handle end section, so that the handle can be folded over approximately about its end section. As an alternative, a pivot axis of this kind can also be arranged parallel to the longitudinal direction of the handle at a distance from said handle, wherein the handle can be connected to said pivot axis by means of a bearing web. A parallel joint axis of this kind can be expedient, in particular given an upright orientation of the handle, in order to allow the handle to pivot from a left-hand side of the operator control element to a right-hand side of the operator control element, and vice versa.

However, the handle can also be mounted or connected in an articulated manner to a device housing section such that it can pivot in multiple axes, for example in such a way that a grip part which forms the actual handle is connected in an articulated manner to a supporting element such that it can pivot, said supporting element for its part being mounted on a housing device section such that it can pivot. A multiple-element design of the handle or the articulated connection of said handle of this kind can be used to provide or to fit the operator control element to one of the handle parts, for example to the abovementioned supporting element.

As an alternative, in a development of one embodiment, the operator control element can, however, also be fitted to a housing section or to a body part of the device, for example to a device housing section on which the handle is also mounted, at a distance from the handle and separately from the handle.

The above-mentioned ability to change position can in this case advantageously be designed in such a way that, in addition to the operating positions in which the thumb can be placed on the operator control element, a park position or inoperative position of the handle can advantageously also be provided, in which park position or inoperative position the handle is recessed, for example, into a device body or is stored directly in a location where it does not interfere.

In this case, the operator control element can be arranged directly on a device housing which adjoins the handle or extends in the area surrounding the handle, wherein the device housing can surround, for example, a body part of the device, which body part surrounds the handle, and/or can form a fastening base for the handle. In this case, the operator control element can be mounted onto the device housing or embedded into the device housing or else recessed in the housing, that is to say arranged such that it is set back or embedded in relation to the surrounding housing surface. As an alternative to an arrangement of the operator control element on or in the device housing however, the operator control element can also be provided on a device part which is separate from the device housing, for example on a button supporting arm which projects above the device housing or a button support in the form of a pedestal for example, which button support protrudes out of the actual device housing.

The operator control element and said handles can be arranged directly on the device housing of a gaming machine or of the main device.

In an alternative development of one embodiment, the device having the operator control element and the handle can, however, also be designed as a separate input device which has an interface for connection to the main device, for example in the form of a gaming machine or a PC. Said interface can comprise, for example, a serial interface, for example in the form of a USB interface or a LAN or WLAN interface.

In a separate input device of this kind, a further input means, for example in the form of a keyboard or a mouse pad which is designed in the manner of a touchscreen, or other input means can be provided on the top side of said separate input device. Said handle can be arranged in the region of a front device edge which faces the user or a corresponding body front side section. In this case, said operator control element can advantageously be arranged on a device housing front side which extends transverse to said top side on which the keyboard can be provided.

In this case, the handle can extend at a distance from the device housing, so that the fingers which wrap around the handle do not collide with the device housing, wherein the device housing can possibly have a grip recess or a recessed portion behind the handle.

In order for the thumb to be intuitively placed on the operator control element almost on its own when the thumb is in the natural position, the operator control element can be arranged offset from the handle, in particular transverse to the handle longitudinal axis. If, in a development of one embodiment, the handle is oriented horizontally, the operator control element can advantageously be arranged beneath the handle when the handle is in one of its operating positions. If the handle is, as an alternative, oriented upright in the operating position, the operator control element can be arranged to the left of the handle for a right-handed grip in a first operating position and to the right of the handle for a left-handed grip in a second operating position. In principle however, an operator control element of this kind can also be provided on both sides of the handle for a two-handed grip on the handle.

As an alternative or in addition to the abovementioned transverse offset of the handle in relation to the operator control element in the operating positions of said handle, the operating positions of the handle can have an offset in relation to the operator control element in the longitudinal direction of the handle too, in particular in such a way that the operator control part is arranged at a distance from the handle or a grip section of the handle, which is provided for the ball of the hand or the index finger and/or middle finger and/or ring finger and/or little finger, in particular displaced slightly beyond the end of the handle or the grip section which the index finger grips during use as intended, so that the thumb, which obliquely projects beyond the end of the handle, comes to lie on the operator control element by way of the tip of the thumb or the last thumb phalange when the hand grasps the abovementioned handle with the fingers.

In this case, the distance of the operator control element from the handle or the grip section of said handle in the respective operating positions of said handle is advantageously restricted to the conventional reach of a thumb of a hand of average size and can be a few centimeters transverse to the handle longitudinal axis and/or in the direction of the handle longitudinal axis.

Here, the operator control element can be oriented approximately parallel to the longitudinal axis of the handle in the operating position of said handle, but as an alternative can also be arranged tilted or inclined at an acute angle in relation to the longitudinal axis of the handle in a single axis or else in multiple axes, wherein said principal axis of the operator control element can also be oriented in a skewed manner in relation to the handle.

In a development of one embodiment, the operator control element can have an operating surface for the thumb, which operating surface is oriented in an upright manner. In particular, the operator control element can have an operating surface which lies in a plane or adjoins a plane which is arranged at least approximately parallel in relation to the handle longitudinal axis or else can be arranged such that it is inclined at an acute angle, for example inclined at an angle of 10-30 degrees. Said plane and the handle can in this case define a wedge converging approximately in the region of the ball of the hand, that is to say the support surface widens further away from the handle as the distance from said handle increases.

In an advantageous development of one embodiment, the operator control element can be arranged on a front side of the device, which front side faces the user of the device and is at least approximately upright, so that the operator control element faces a user standing in front of the device and a thumb tip facing away from the body of the user can be placed onto the operator control element.

As an alternative or in addition to an ability to tilt or rotate in this way, the operator control element can also be mounted such that it can be displaced in a translatory manner, in particular in a plane approximately parallel to the housing side on which the operator control element is provided. By way of example, the operator control element can be displaced upward and downward and/or to the right and left in an upright device housing front side in order to be able to set an optimum position relative to the handle in the operating positions of said handle or the above-described support surface of said handle for the fingers. If the operator control element is arranged on a device housing side which is oriented in a horizontal manner, the operator control element can be displaced to the right and left and/or to the front and rear.

In this case, a fingerprint sensor can be fitted to the operator control element, for example can be integrated into the operating surface of said operator control element. In this case, a fingerprint sensor of this kind can serve to identify the user of the respective device, wherein the biometric data, for example of the thumb or of a fingertip, detected by the operator control element can be used in various ways. By way of example, a release apparatus which can be connected to the operator control element can, as a function of the detected fingerprint, release a device function, for example lift a device lock or release an entry barrier, if the detected fingerprint corresponds, or comes sufficiently close, to a stored fingerprint or, conversely, deviates sufficiently from a stored fingerprint; that is to say the fingerprint can be used to check whether an authorized or a barred person is attempting to operate the device.

As an alternative or in addition to a release function of this kind, the operator control element can also be connected to a device setting apparatus, by means of which personal device settings, such as screen position, character and/or letter size or other image display options for example, or else, for example, a game preselection can be preconfigured in a user-specific manner on the basis of the detected fingerprint.

As an alternative or in addition, the fingerprint sensor can also be connected to a user detection device which, as a function of the respectively detected fingerprint, ascribes use data to an individual user account, for example stores use times or obtained winnings in a user account or debits gaming stakes from a user account, as a function of the respective fingerprint.

In order to avoid an unnatural spread of the thumb when the thumb is placed onto the fingerprint sensor when the other fingers wrap around the handle, the fingerprint sensor, which is integrated into the operator control element, can, in a development of one embodiment, be arranged with a principal axis tilted, in particular inclined at an acute angle, in relation to the longitudinal axis of the handle. Said principal axis of the operator control element can in this case be a longitudinal center axis of the support face of the fingerprint sensor and/or a principal axis of the image sensor system of the operator control element, in which principal axis the evaluation device of the operator control element expects a principal axis of the print image, in particular the thumb tip longitudinal axis.

### BRIEF DESCRIPTION OF THE DRAWINGS

FIG. 1: shows a schematic top view of a device housing section with a handle which is gripped by the fingers of a hand, wherein an operator control element which is arranged on an upright device housing front side is arranged laterally beneath the handle, so that a thumb tip can touch and push the operator control element,

FIG. 2: shows a perspective front view of the device housing section from FIG. 1, wherein the handle, the position of which can be changed, is shown in various positions relative to the operator control element in order to be able to selectively place the left hand or the right hand and position the corresponding thumb on the operator control element,

FIG. 3: shows a schematic top view of the top side of the device housing section from FIG. 6, wherein the handle is pivoted into the position for left-handed operation,

FIG. 4: shows a front view of the device housing section from FIG. 1, wherein, in accordance with a further embodiment, a two-member pivotable handle is provided, which handle can be moved between two operating positions for right-handed and left-handed use and also a park position, and which handle carries the operator control element on the movable supporting strut of said handle, wherein, in accordance with FIG. 4, the handle is shown in an operating position for the right hand and the operating position for the left hand is shown in a dashed line illustration,

FIG. 5: shows a front view of the device housing section similar to FIG. 4, wherein the handle is shown in its park position or inoperative position,

FIG. 6: shows a top view of the device housing section from the two preceding FIGS., wherein the handle is shown in its operating position for the left hand, and

FIG. 7: shows an overview of a device in the form of a gaming and/or entertainment machine, which comprises screens and a horizontally aligned operator control panel with input means, wherein an embodiment according to the prior art is depicted, in which an operator control element is provided centrally on a top side of the operator control panel.

### DETAILED DESCRIPTION OF CERTAIN INVENTIVE EMBODIMENTS

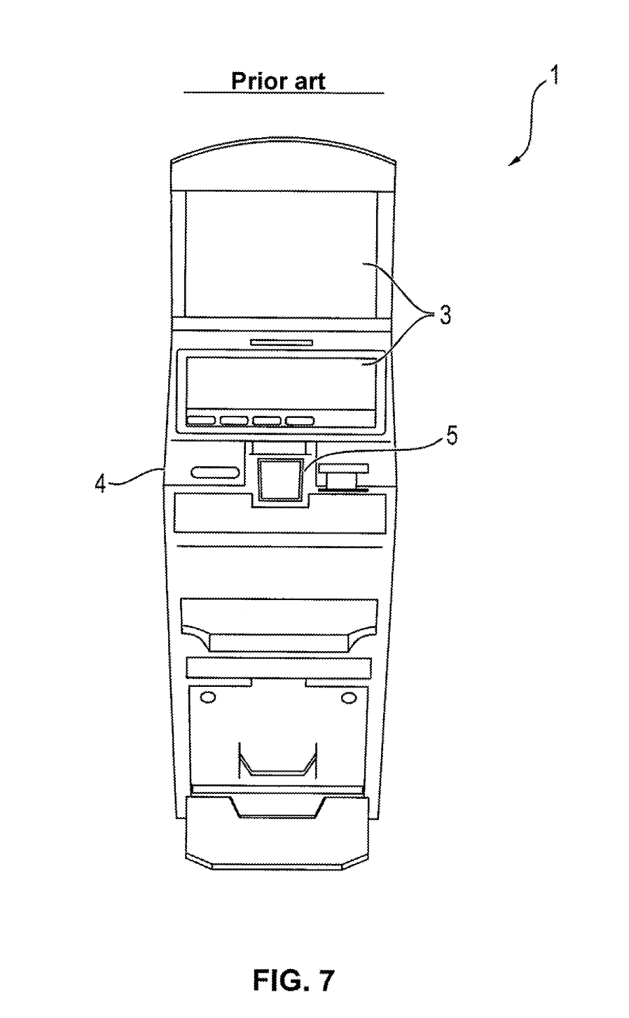

As shown in FIG. 7—even though said figure shows an operator control element arrangement according to the prior art—a device which implements one embodiment can be designed, for example, as a gaming and/or entertainment device, as is used in casinos or amusement arcades, wherein the device can be designed, for example, as a stand-alone device. The device 1 can comprise a device housing which—loosely speaking—can have an approximately cubic shape, but also can be of a sculpture-like design. One or more screens 3 can be arranged on said device housing 2, but other display means, such as rotating reels for example, can also be provided.

A device housing section 4, which can advantageously be oriented in a horizontal manner and, for example, be formed in a panel-like manner, can act as operator control section, wherein input means, for example in the form of operator control buttons or touchscreen elements, can be provided on said device housing section 4.

A handle for supporting the hand of an operator of the device and also an operator control element which is associated with said handle can be provided directly on said device housing section 4 of the gaming machine in this case.

As an alternative however, an input device which is designed separately from the gaming device or main device 1 can also be provided, as is shown in FIGS. 1 to 7 for example. An input device of this kind can have a suitable interface for connection to the main device, which can also be a PC or a gaming console, as will be explained in further detail. An input device of this kind likewise comprises a device housing 2 which has a device housing section 4 which is advantageously oriented in a horizontal manner and overall is formed—loosely speaking—in a cubic or panel-like manner.

As shown in FIGS. 1 to 3, said device housing section 4 can comprise a handle 6 which can be arranged in a horizontal manner on a front side of the device housing section 4. In particular, said handle 6—loosely speaking—can be designed in the form of a rod and/or arranged on a housing edge 7 which connects a horizontal top side 8 and an upright front side 9 of the device housing section 4. Here, the device housing section 4 can comprise a recess 10 around the handle 6, so that a hand 20 can wrap around the handle 6 by way of the index finger, middle finger, ring finger and little finger. The necessary clearance for wrapping around the handle 6 can, however, also be obtained by a, for example, arcuate or projecting contouring of the handle 6, so that said recess 10 is not mandatory.

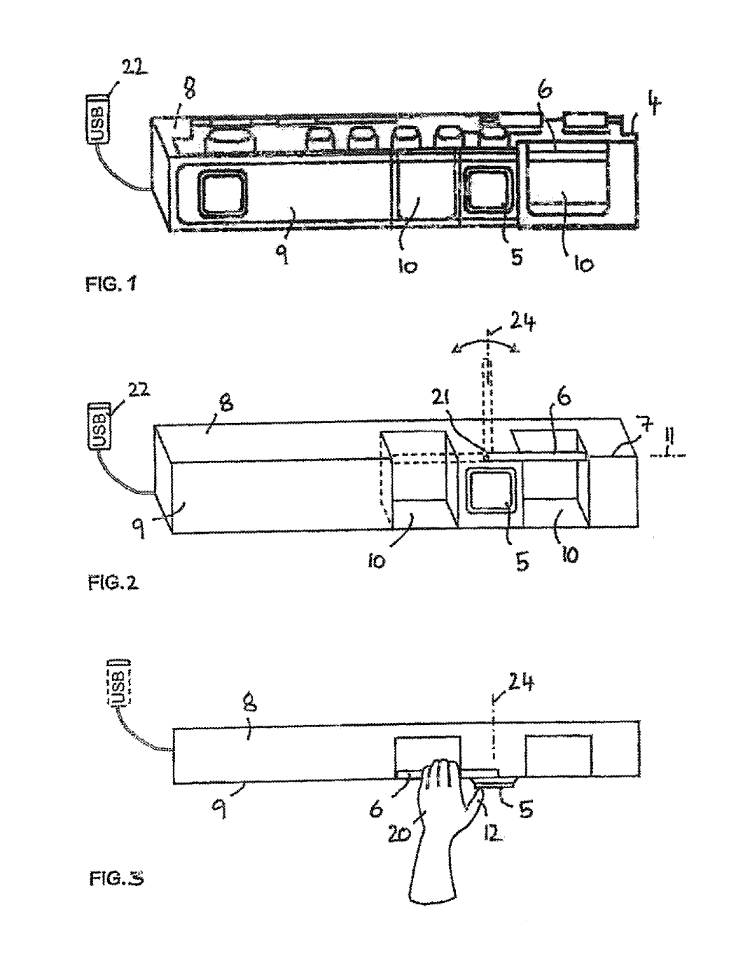

As shown in FIGS. 1 and 2, an operator control element 5 can be associated with the handle 6, which operator control element is arranged at a distance from an end of the handle 6 transverse to the longitudinal axis 11 of the handle 6 and also in the direction of said longitudinal axis 11. In particular, said operator control element 5 can be arranged on the upright front side 9 of the device housing section 4, wherein the operator control element 5 can be arranged slightly beneath the handle 6 and at a distance from the handle 6 to one side—to the left in accordance with FIG. 2—so that a thumb 12 which does not wrap around the handle 6 but instead is spread away from the handle 6 comes to lie on said operator control element 5 in the natural, intuitive thumb position.

The distance of the operator control element 5 from said handle 6 transverse to the handle longitudinal axis 11 and/or in the direction of the handle longitudinal axis 11 from the handle end (downward and to the left in respect of the handle 6 in accordance with FIG. 2) advantageously equals the distance of the thumb tip from the root joint of the index finger, that is to say the usual thumb reach when the thumb is splayed, and can be a few centimeters.

As an alternative or in addition, the operator control element 5, by way of its support surface, can also be tilted in relation to the device housing front side 9 or the handle longitudinal axis 11 about a horizontal tilting axis (not shown).

As shown in FIGS. 2 and 3, the handle 6 is designed such that the position of said handle can be changed, in particular is designed in such a way that the handle 6 can be moved to two different operating positions relative to the operator control element 5. In this case, one operating position can serve for left-handed operation and the other operating position can serve for right-handed operation of the operator control element 5.

The ability to change the position of the handle 6 can in this case, in particular, have a mirror-image quality or symmetry in relation to the operator control element 5, in particular in such a way that the two said operating positions are symmetrical with respect to a plane of symmetry 24 passing through the operator control element 5.

In particular, the handle 6 can have a first operating position in which an at least relatively large part of the handle 6 is situated on a right-hand side of the operator control element 5 while an at least relatively large part of the handle 6 is situated on a left-hand side of a operator control element in a second operating position.

By way of example, the handle 6 can be mounted such that it can pivot, as shown in FIG. 2, wherein the handle 6 can have a pivot axis 21 perpendicular to the longitudinal direction of the handle 6 here, which pivot axis can extend approximately centrally with respect to the operator control element 5, for example can be arranged centrally above said operator control element 5. As an alternative or in addition to pivotable mounting of this kind about the pivot axis 21 however, the handle 6 can also be moved or the position of said handle can be changed in a different way, for example by reconnection between two or more operating positions and/or by the ability to displace the handle 6, for example in the form of displaceable mounting of the handle 6 parallel to the longitudinal axis of said handle.

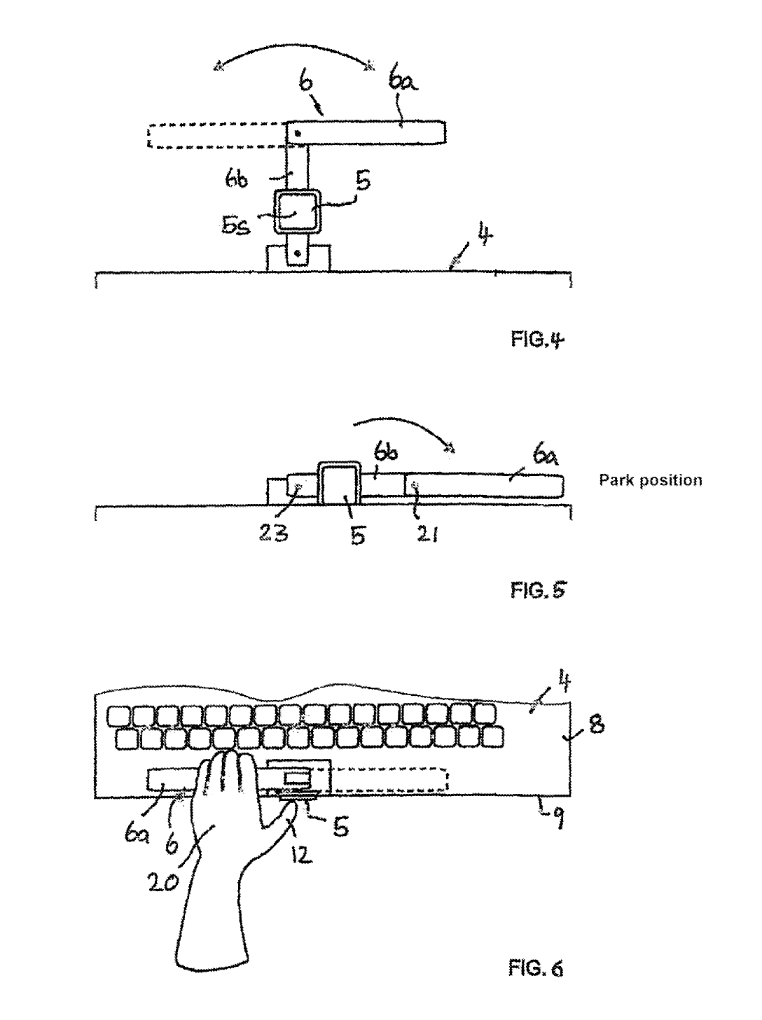

Looking at FIG. 6, the handle 6 could also be moved from the right-handed operating position, illustrated using a solid line, to the left-handed operating position, illustrated using dashed lines, by displacement in the longitudinal direction.

In this case, the handle 6, in its operating positions, is in each case positioned relative to the operator control element 5 in such a way that the thumb of the right or left hand can be positioned on the operator control element 5 in said manner. In order to be able to provide the above-described acute-angle orientation or tilting of the operator control element 5 in a suitable manner for both operating positions, the operator control element 5 can be suitably mounted in a rotatable or tiltable manner. However, in principle, the operator control element 5 can, in one embodiment, also be mounted rigidly on the device housing section 4 and/or arranged fixed with a preferably parallel orientation in relation to the longitudinal direction of the handle 6.

As likewise shown in FIGS. 2 and 3, the handle 6 can be arranged not only directly on the device housing 2 of the main device 1 or of the gaming machine, but also on a device housing section 4 of an operator control device which is separate from the main device and has an interface 22 in order to be able to be connected to the main device 1. This interface 22 can be a wired parallel or serial interface, for example in the form of a USB interface or an RS-232 interface, or else it can be an interface working on wireless principles, for example in the form of a WLAN interface or Bluetooth interface or IrDA interface operating on the basis of infrared signals, or a combination of these interfaces.

As shown in FIGS. 4 to 6, the handle 6 can also be of multiple-element design, for example in order also to be able to assume a park position or inoperative position, which is shown in FIG. 5, in addition to the two operating positions.

In particular, the handle 6 can comprise a grip element 6a, which forms the actual handle on which the ball of the hand can be supported and around which the fingers of a hand can be wrapped, wherein said grip element 6a can be designed, for example, in an elongate manner or in the form of a rod. Said grip element 6a can be supported on a supporting element 6b, which supporting element 6b can be mounted in a movable manner on the device housing section 4. By way of example, said supporting element 6b of the handle 6 can be mounted such that it can pivot about a pivot axis 23 which extends perpendicular to the longitudinal direction of the supporting element 6b. The grip element 6a of the handle 6 can, for its part, be connected in an articulated manner to said support member 6b such that it can pivot, wherein the pivot axis 21 of the grip element 6a can, for its part, extend perpendicular to the longitudinal direction of said grip element.

Said supporting element 6b forms, as it were, a guide for the articulated connection of the grip element 6a on the device housing section 4 which can be part of the device housing of the main device or of a separate operator control device.

Advantageously, in one embodiment, the ability of the handle 6 to move can be formed in such a way that the handle 6 can be moved to a park position in which the handle 6, preferably including the grip element 6a and the supporting element 6b of said handle, adjoins the device housing section 4 or extends adjacent to said housing section along the latter and is tidied away, as it were, in a space-saving manner.

In order to move the handle 6 to its operating position, the supporting element 6b is raised or positioned in a manner projecting, for example in a perpendicular manner, from the device housing section 4 and advantageously fixed, for example by a detachable plug-in interlocking connection or a screw-in clamping connection or else a self-locking latching connection. The grip element 6a can be angled in relation to the supporting element 6b.

By pivoting said grip element 6a, it is possible, in particular, for the two abovementioned operating positions to be set, that is to say, in particular, a first operating position in which an at least relatively large part of the grip element 6a is situated on a right-hand side of the operator control element 5, while an at least relatively large part of the grip element 6a is situated on a left-hand side of the operator control element 5 in a second operating position.

The operator control element 5 can be arranged on said supporting element 6b and therefore on the handle 6, wherein the arrangement can once again be formed such that, when the index finger, middle finger, ring finger and/or little finger of a hand wrap/wraps around the grip element 6a, the thumb of said hand can be placed on the operator control element 5 next to the handle element 6a.

As shown in FIGS. 4 and 6, the grip element 6a of the handle 6 can be moved to the two operating positions shown, selectively in a manner gripped by the left hand or the right hand in order to be able to operate the operator control element 5.

Instead of the ability to pivot shown in FIGS. 4 to 6, an ability to change position can also be provided in a different way in the case of a multiple-element design of the handle 6, for example by reconnection or displacement. By way of example, the grip element 6a can be plugged onto the supporting element 6b in different positions and the supporting element 6b can be securely plugged in different positions on the device housing section 4.

According to one exemplary embodiment, the device housing section 4 can be part of a PC keyboard (computer keyboard), that is to say the, in particular multiple-element, handle 6 can form a constituent part of a PC keyboard of this kind.

As described in the introductory part, the abovementioned operator control element 5 can be a pushbutton or a touch button for triggering a corresponding gaming function or another device function, in particular can form a gamble button. As an alternative or in addition to a control function of this kind, the operator control element 5 can also have a fingerprint sensor 5s or a fingerprint sensor 5s of this kind can be integrated, in particular, into the operating surface of the operator control element 5. If the thumb or the tip of the thumb comes to lie on the operator control element 5, said fingerprint sensor 5s can detect the fingerprint of the operator of the device.

It is to be understood that any feature described in relation to any one example may be used alone, or in combination with other features described and may also be used in combination with one or more features of any other of the examples, or any combination of any other of the examples. Furthermore, equivalents and modifications not described above may also be employed without departing from the scope of the accompanying claims.

What is claimed is:

1. A device comprising:
at least one handle in the form of a rod;
at least one operator control element arranged relative to the handle in such a way that when one or more fingers of a hand wrap the handle, a thumb of the hand can be placed on the operator control element;
wherein the position of the handle can be varied relative to the operator control element so that the handle can be:
a) moved to a first operating position for operation by the hand when the hand is a left hand; and;
b) moved to a second operating position for operation by the hand when the hand is a right hand.

2. The device of claim 1, wherein:
the handle is oriented horizontally in at least one of the first or second operating positions; and
the operator control element is arranged beneath the horizontally oriented handle.

3. The device of claim 1, wherein the operator control element is offset from the handle transverse to the handle longitudinal axis and is arranged at a distance from the handle and/or a grip section of the handle in the direction of the handle longitudinal axis in both operating positions of the handle.

4. The device of claim 1, wherein the handle is mounted such that it can move back and forth between two operating positions, which operating positions are arranged symmetrically with respect to a plane of symmetry and/or symmetry axis which passes through the operator control element.

5. The device of claim 1, wherein an at least relatively large portion of the handle is situated on a right-hand side of the operator control element in the first operating position, and an at least relatively large portion of the handle is situated on a left-hand side of the operator control element in the second operating position.

6. The device of claim 1, wherein the handle is mounted such that it can move between at least one operating position and a park position.

7. The device of claim 1, wherein the handle is mounted such that it can pivot about at least one pivot axis, which extends perpendicular to the longitudinal direction of the handle at an end section of the handle.

8. The device of claim 1, wherein the operator control element is arranged such that it can move relative to the operating positions of the handle such that it can rotate and/or can tilt and/or can be displaced in a translatory manner.

9. The device of claim 1, wherein the operator control element has an operating surface which is oriented in an upright manner.

10. The device of claim 1, wherein the operator control element has a fingerprint sensor integrated into an operating surface of the operator control element.

11. The device of claim 1, wherein the device is a gaming device configured to accept a bet.

12. The device of claim 1, wherein:
the handle comprises a plurality of handle parts which can change position relative to one another; and
the operator control element is fitted to one of the handle parts.

13. The device of claim 12, wherein the plurality of handle parts comprise a grip element which can pivot in multiple axes and which can pivot about a pivot axis relative to at least one supporting element of the handle, the supporting element itself being mounted such that it can pivot about a pivot axis to a device housing section.

14. The device of claim 13, wherein at least two pivot axes of the handle are oriented parallel in relation to one another.

15. The device of claim 1, wherein the device is designed as an operator control device which is separate from a main device, the operator control device having an interface for connection to the main device.

16. The device of claim 15, wherein the operator control element is provided on a front side of the operator control device, and the operator control device comprises a keyboard.

17. The device of claim 16, wherein the separate operator control device is designed as a computer keyboard on which the handle and the operator control element are provided.

18. The device of claim 17, wherein the handle is detachably fastened to a housing section of the computer.

19. The device of claim 1, wherein a fingerprint sensor is associated with the handle separate from the operator control element, it being possible to operate said fingerprint sensor by a thumb which is splayed from the handle the one or more fingers of the hand wraps around the handle.

20. The device of claim 19, wherein the handle can selectively be moved to different operating positions in which the thumb can selectively be placed on the fingerprint sensor and the operator control element.
